(19) United States
(12) Patent Application Publication
(10) Pub. No.: US 2014/0233630 A1
(43) Pub. Date: Aug. 21, 2014

(54) APPARATUS AND METHOD FOR ADAPTIVE LAYER SELECTION AND SERVER HAVING THE SAME

(71) Applicant: Electronics and Telecommunications Research Institute, Daejeon-si (KR)

(72) Inventors: Tae Jung KIM, Cheongju-si Chungbuk (KR); Chang Ki KIM, Daejeon-si (KR); Jeong Ju YOO, Daejeon-si (KR); Jin Woo HONG, Daejeon-si (KR); Byung Gyu KIM, Cheonan-si Chungcheongnam-do (KR); Gwang Soo HONG, Seoul (KR)

(73) Assignee: Electronics and Telecommunications Research Institute, Daejeon-si (KR)

(21) Appl. No.: 13/967,861

(22) Filed: Aug. 15, 2013

(30) Foreign Application Priority Data
Feb. 18, 2013 (KR) 10-2013-0017098

(51) Int. Cl. H04N 7/26

(52) U.S. Cl. CPC H04N 19/00206
USPC 375/240.02

(57) ABSTRACT

An apparatus and method for adaptive layer selection and a server having the same are provided. The adaptive layer selecting apparatus includes a monitoring unit monitoring a connection state of at least one channel connected through a communication network, a channel managing unit detecting available channels to be used for providing a service based on a result of the monitoring, and a layer managing unit determining the number of adaptive layers to be used for encoding based on bandwidths of changed available channels when the number of the available channels is changed.

### CROSS-REFERENCE TO RELATED APPLICATION

This application claims priority to Korean Patent Application No. 10-2013-0017098 filed on Feb. 18, 2013, the contents of which are herein incorporated by reference in its entirety.

### BACKGROUND OF THE INVENTION

1. Technical Field

The present invention concerns an apparatus and method for adaptive layer selection and a server having the same, and more specifically, to an apparatus and method of selecting the number of adaptive layers for efficiently compressing scalable video signals and a server having the same.

2. Discussion of the Related Art

General scalable coding is designed to adaptively correspond to a change in bandwidth of a transmission channel by entering an image (1_{—}b, 1_{—}c) obtained by reducing the spatial resolution of an input image (1_{—}a) to a lower layer as shown in FIG. 1 for spatial scalability in order to be able to support various transmission environments and a number of terminals. As such, a use of hierarchical B screen coding may allow for coding efficiency as much as about two times the coding efficiency obtained by independently coding each view point simply with H.264/AVC (Advanced Video Coding).

A scalable video coding scheme performs compression by basically incorporating original images prepared to include various qualities with layer information by several prediction schemes. At the final decoding stage, decoding is conducted up to selectively possible layer depending on performance of a corresponding connected terminal or characteristics of a connected channel.

Such scalable video coding scheme, which is a technology for collectively treating video information in a number of transmission environments and various types of terminals, generates single integrated data supportable for various spatial resolutions, frame rates, and qualities, and effectively transfers data to various terminals and transmission environments.

A currently used scalable video coding scheme has the structure in which after channel characteristics and terminal performance are once entered into negotiations, the same number of layers is continuously encoded by an encoding server. In other words, if any smart phone may perform encoding up to HD level or so, the server first acknowledges through connection to a terminal and continuously performs encoding up to HD level.

Meanwhile, recent terminals support one or more network functions. In other words, a smart phone's functions are being expanded to gain simultaneous access to several networks such as WiFi, 3G, or LTE (Long Term Evolution). To catch up with such technical development and to efficiently utilize the advanced hardware technologies, not only is a single initial specific network channel used but a media service structure through multi-channel connection should be considered as well. That is, in case a 3G channel and a WiFi channel are both accessible, these two channels both should be utilized, and in case the 3G channel only is possible, a video service with a proper number of layers needs to be provided via the 3G channel.

Accordingly, there is a need for a technology to effectively compress scalable video signals according to the channel connection state when using a scalable video encoder scheme to establish a media service through multi-channel connection.

[Patent Document] Korean Patent Application Publication No. 10-2010-0113365 entitled “channel adaptive video transmission method, apparatus using the method, and system providing the same”, as assigned to Samsung Electronics and published by Oct. 21, 2010.

### SUMMARY OF THE INVENTION

To address the above problems, an object of the present invention is to provide an apparatus and method for adaptive layer selection to determine the number of encoding layers based on basic bandwidth information of a channel when the number of connectable channels is changed under the condition where multi-channel connection is available and a server having the same.

Objects of the present invention are not limited thereto, and unmentioned other technical objects may be apparently understood by one of ordinary skill in the art.

To achieve the above-described objects of the present invention, according to an aspect of the present invention, an adaptive layer selecting apparatus includes a monitoring unit monitoring a connection state of at least one channel connected through a communication network, a channel managing unit detecting available channels to be used for providing a service based on a result of the monitoring, and a layer managing unit determining the number of adaptive layers to be used for encoding based on bandwidths of changed available channels when the number of the available channels is changed.

The monitoring unit detects the type of a terminal first connected through the communication network.

The monitoring unit defines an expense function by using a main processor clock count and the number of processor cores determined according to the type of the terminal.

The monitoring unit determines the initial maximum number of layers consumable by the terminal when the terminal first accesses by using the expense function and a weighting factor predetermined according to the type of the terminal.

When the number of the available channels is changed while a service is being provided in the initial maximum layer number, the layer managing unit determines the adaptive layer number based on a sum of the bandwidths of the changed available channels.

The channel managing unit transfers channel management information including the number of the available channels and the bandwidth of each available channel to the layer managing unit.

The layer managing unit determines whether the number of the available channels is changed using the channel management information.

When the number of the available channels is changed, the layer managing unit determines the adaptive layer number by adjusting the maximum number of layers serviceable by an encoder according to a result of comparison between a data rate of the initial maximum layer number and the sum of the bandwidths of the changed available channels.

The in a case where the number of the available channels is not changed or in a case where the number of the available channels is changed but the bandwidths of the changed available channels are not sufficient, the layer managing unit determines the current number of layers as the adaptive layer number.

To achieve the above-described objects of the present invention, according to another aspect of the present invention, an adaptive layer selecting method includes monitoring a connection state of at least one channel connected through a communication network, detecting available channels to be used for providing a service based on a result of the monitoring, and determining the number of adaptive layers to be used for encoding based on bandwidths of changed available channels when the number of the available channels is changed.

The monitoring includes detecting the type of a terminal first connected through the communication network, defining an expense function by using a main processor clock count and the number of processor cores determined according to the type of the terminal, and determining the initial maximum number of layers consumable by the terminal when the terminal first accesses by using the expense function and a weighting factor predetermined according to the type of the terminal.

The adaptive layer selecting method further includes determining whether the number of the available channels is changed using channel management information including the number of the available channels and the bandwidth of each available channel.

Determining the adaptive layer number includes when the number of the available channels is changed, determining the adaptive layer number by adjusting the maximum number of layers serviceable by an encoder according to a result of comparison between a data rate of the initial maximum layer number and the sum of the bandwidths of the changed available channels and in a case where the number of the available channels is not changed or in a case where the number of the available channels is changed but the bandwidths of the changed available channels are not sufficient, determining the current number of layers as the adaptive layer number.

To achieve the above-described objects of the present invention, according to an aspect of the present invention, a server includes an adaptive layer selecting unit monitoring a connection state of at least one channel connected through a communication network, determining whether the number of available channels based on a result of the monitoring, and determining the number of adaptive layers to be used for encoding and an encoder performing encoding based on the adaptive layer number transferred from the adaptive layer selecting unit.

The adaptive layer selecting unit controls a transfer time such that, when the number of the available channels is changed during a first GOP unit and the adaptive layer number is determined, the adaptive layer number applies at a start of a second GOP unit after the first GOP unit is terminated.

The adaptive layer selecting unit determines the initial maximum number of layers consumable by a terminal that first accesses through the communication network.

When the number of the available channels is changed while a service is provided in the initial maximum layer number, the adaptive layer selecting unit determines the adaptive layer number by comparing a sum of bandwidths of the changed available channels with a data rate of the initial maximum layer number.

To achieve the above-described objects of the present invention, according to another aspect of the present invention, an adaptive layer selecting method by a server includes monitoring a connection state of at least one channel connected through a communication network by an adaptive layer selecting unit, determining whether the number of available channels based on a result of the monitoring and determining the number of adaptive layers to be used for encoding by the adaptive layer selecting unit, transferring the adaptive layer number to an encoder by the adaptive layer selecting unit, and performing encoding based on the adaptive layer number by encoder.

The adaptive layer selecting method by the server further includes monitoring a terminal that first accesses through the communication network by the adaptive layer selecting unit and determining the initial maximum number of layers consumable by the terminal when the terminal first accesses based on the type of the terminal by the adaptive layer selecting unit.

Determining the adaptive layer number includes, by the adaptive layer selecting unit, determining whether the number of the available channels is changed while a service is provided in the initial maximum layer number, in a case where the number of the available channels is changed, determining the adaptive layer number by adjusting the maximum number of layers serviceable by the encoder according to a result of comparison between a sum of bandwidths of the changed available channels and a data rate of the initial maximum layer number, and in a case where the number of the available channels is not changed or in a case where the number of the available channels is changes but the bandwidths of the changed available channels are not sufficient, determining the current number of layers as the adaptive layer number.

According to the above-described apparatus and method for adaptive layer selection and the server having the same, the number of layers is adaptively determined depending on the multichannel connection state as well as the type of a terminal, and thus, a low-power scalable video service may be provided which may maximally utilize available channels.

Further, rather a designated number of layers being not always compressed and transmitted in a multi-channel circumstance, layers the number of which is changed according to the number of available channels and a basic bandwidth are adaptively compressed and provided, so that a scalable video service may be more efficiently provided in light of the calculation load of the encoding server or power consumption.

These effects may be more efficiently provided in an environment with a number of encoding servers and may be further expanded in a multi-channel connection environment as network technology advances.

### BRIEF DESCRIPTION OF THE DRAWINGS

The embodiments of the present invention will become readily apparent by reference to the following detailed description when considered in conjunction with the accompanying drawings wherein:

FIG. 1 is a view schematically illustrating a general scalable video coding structure;

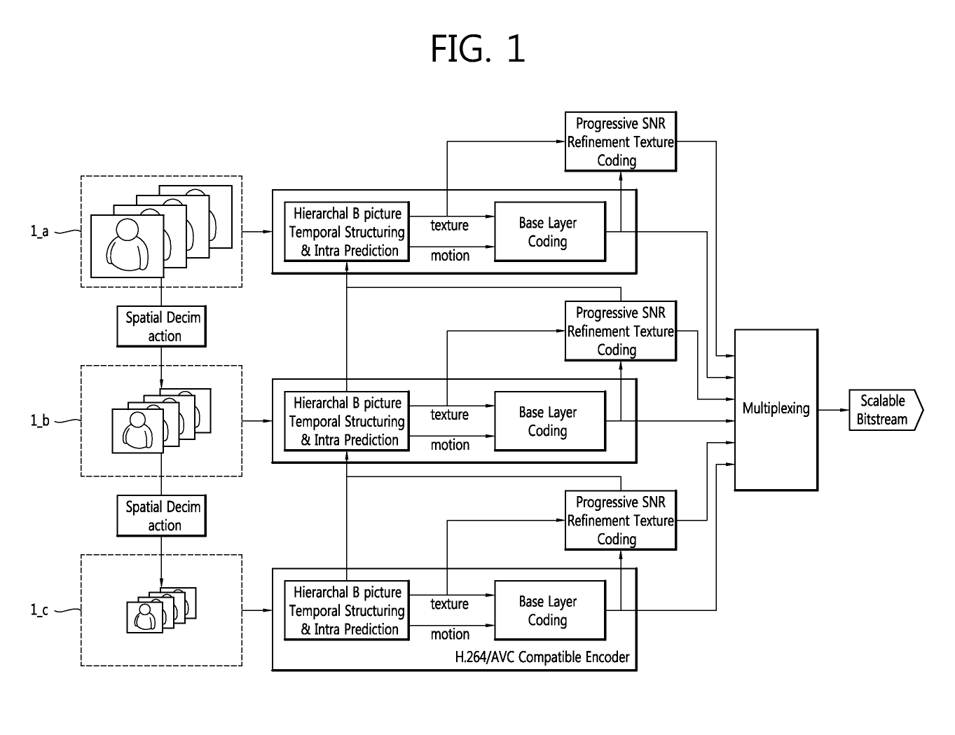

FIG. 2 is a concept view illustrating providing a multi-channel based scalable video service according to an embodiment of the present invention;

FIG. 3 is a view schematically illustrating a processing unit of a scalable video encoding scheme according to an embodiment of the present invention;

FIG. 4 is a view illustrating an example of a data rate up to the maximum number of serviceable layer according to an embodiment of the present invention;

FIG. 5 is a view illustrating an example of per-channel bandwidth information and per-terminal basic data consumption information;

FIG. 6 is a view illustrating an example of a time when an adaptive number of layers apply according to an embodiment of the present invention; and

FIG. 7 is a flowchart illustrating a method for providing a multi-channel connection-based scalable video service according to an embodiment of the present invention.

### DESCRIPTION OF THE EMBODIMENTS

Various modifications may be made to the present invention and the present invention may have a number of embodiments. Specific embodiments are described in detail with reference to the drawings. However, the present invention is not limited to specific embodiments, and it should be understood that the present invention includes all modifications, equivalents, or replacements that are included in the spirit and technical scope of the present invention.

The terms “first” and “second” may be used to describe various components, but the components are not limited thereto. These terms are used only to distinguish one component from another. For example, the first component may be also named the second component, and the second component may be similarly named the first component. The term “and/or” includes a combination of a plurality of related items as described herein or any one of the plurality of related items.

When a component is “connected” or “coupled” to another component, the component may be directly connected or coupled to the other component. In contrast, when a component is directly connected or coupled to another component, no component intervenes.

The terms used herein are given to describe the embodiments but not intended to limit the present invention. A singular term includes a plural term unless otherwise stated. As used herein, the terms “include” or “have” are used to indicate that there are features, numerals, steps, operations, components, parts or combinations thereof as described herein, but do not exclude the presence or possibility of addition of one or more features, numerals, steps, operations, components, parts or components thereof.

Unless defined otherwise, all the terms including technical or scientific terms as used herein have the same meanings as those generally understood by one of ordinary skill in the art. Such terms as generally defined in the dictionary should be interpreted as having meanings consistent with those understood in the context of the related technologies, and should not be construed as having excessively formal or ideal meanings unless clearly defined in the instant application.

Hereinafter, preferred embodiments of the present invention will be described in detail with reference to the accompanying drawings. For better understanding of the entire invention, the same references are used to denote the same elements throughout the drawings, and description thereof is not repeated.

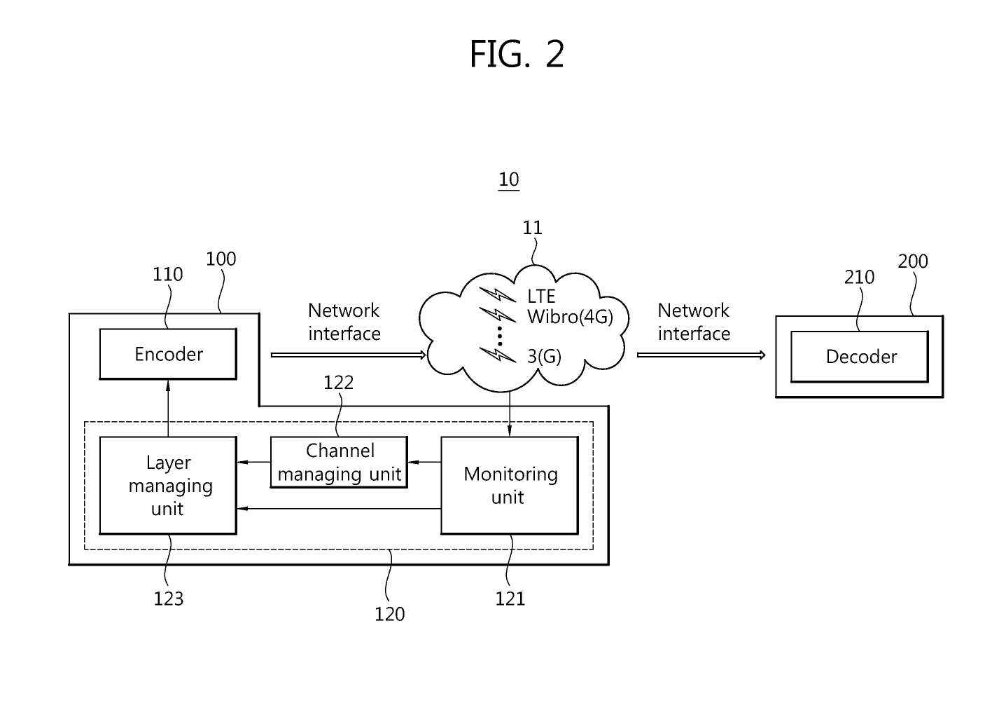

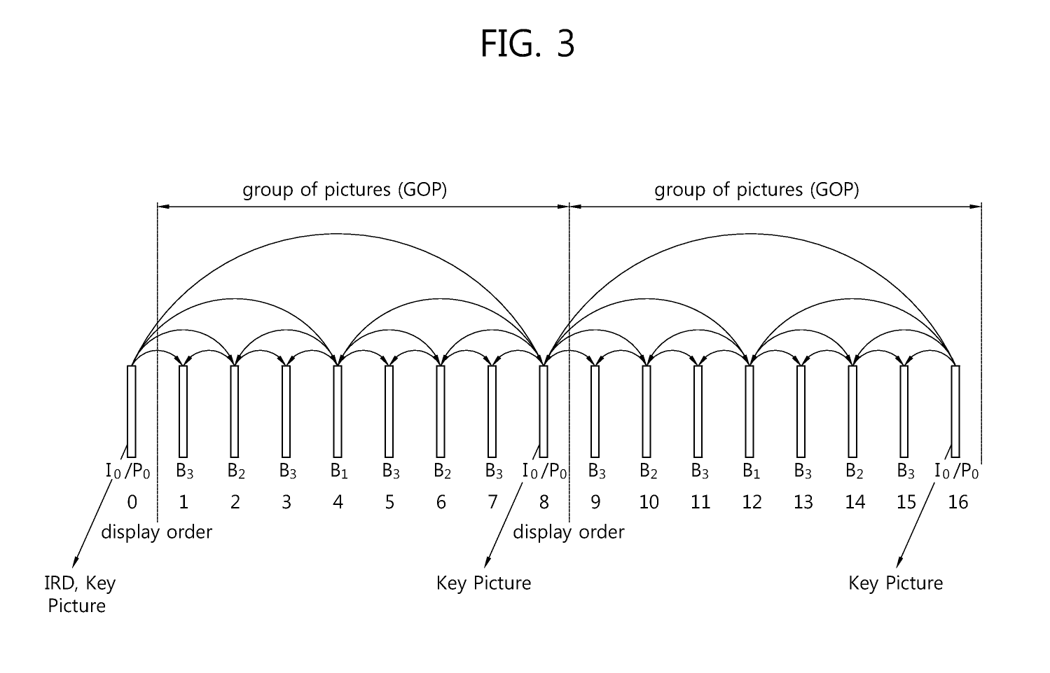

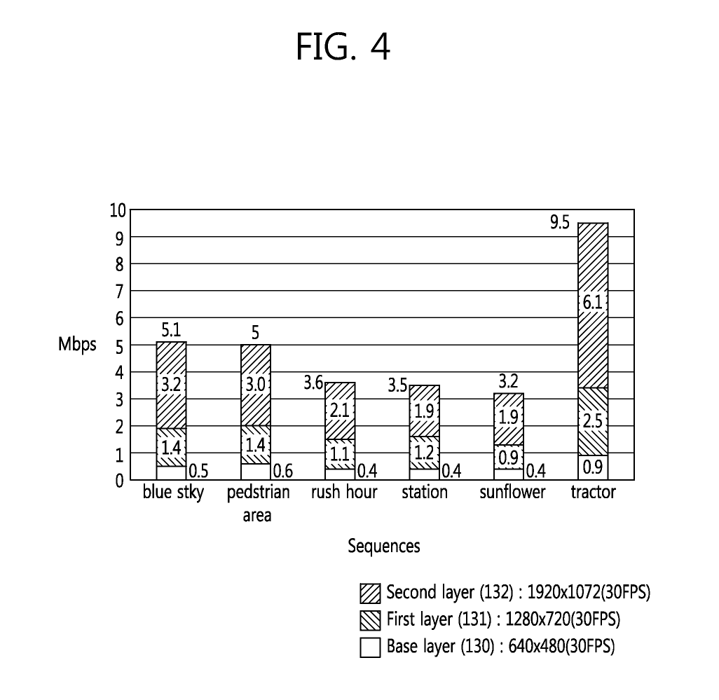

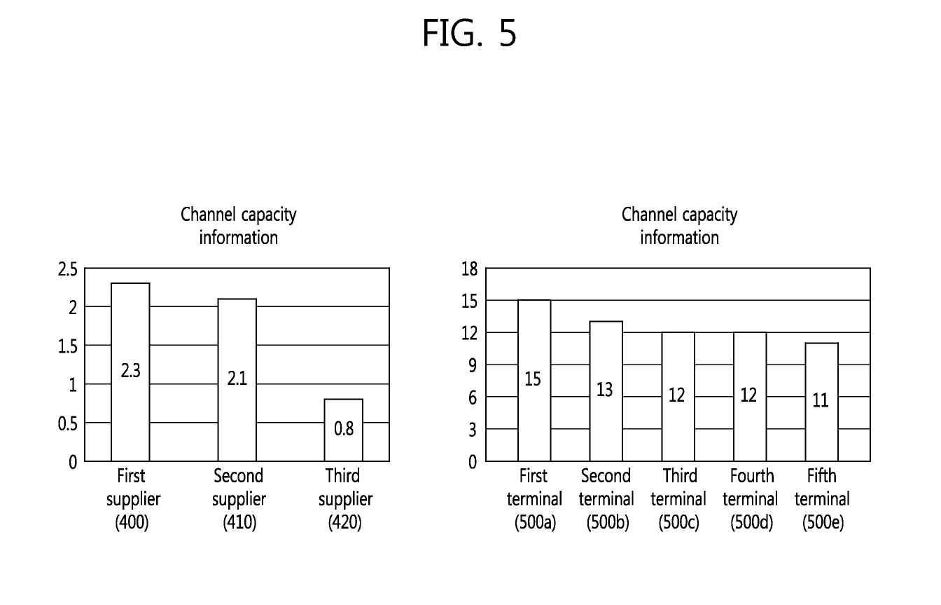

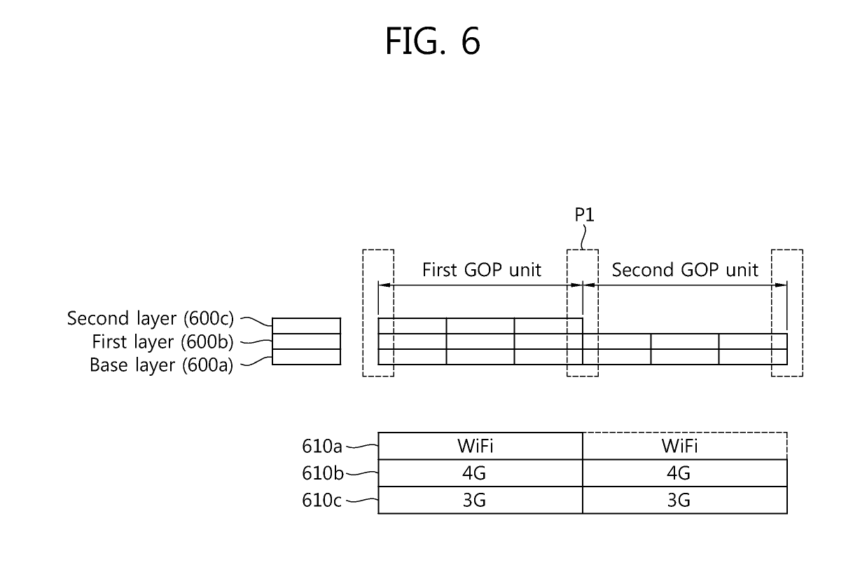

FIG. 2 is a concept view illustrating providing a multi-channel based scalable video service according to an embodiment of the present invention. FIG. 3 is a view schematically illustrating a processing unit of a scalable video encoding scheme according to an embodiment of the present invention. FIG. 4 is a view illustrating an example of a data rate up to the maximum number of serviceable layer according to an embodiment of the present invention. FIG. 5 is a view illustrating an example of per-channel bandwidth information and per-terminal basic data consumption information. FIG. 6 is a view illustrating an example of a time when an adaptive number of layers apply according to an embodiment of the present invention.

As shown in FIG. 2, in a system 10 for providing a multi-channel connection based scalable video service according to an embodiment of the present invention, terminals is assumed to be able to simultaneously connect to different types of networks through a communication network 11 that allows for multi-channel connection. In an embodiment of the present invention, a number of multiple channels other than the LTE (Long Term Evolution), 4G, and 3G shown in FIG. 2 may be connected through the communication network 11. The system 10 includes a server 100 and a terminal 200.

The server 100 is connected to the communication network 11 and provides a scalable video service. The server 100 includes an encoder 110 and an adaptive layer selecting unit 120.

The encoder 110 encodes a high-quality digital video stream. In other words, if the number of layers is determined on a per-GOP basis and transferred from the adaptive layer selecting unit 120, the encoder 110 generates a bit stream by reflecting the transferred number of layers and transfers the bit stream to the terminal 200 through the communication network 11. In an embodiment of the present invention, as shown in FIG. 3, a standardized scalable video encoding scheme is used to perform encoding. In the scalable video encoding scheme, a basic process is carried out on a per-group-of-picture (“GOP”) basis, and a control signal for a new image or group is defined on a per-group basis. In other words, in an embodiment of the present invention, the GOP unit is used as a basic time when a change is made to a layer.

Referring back to FIG. 2, the adaptive layer selecting unit 120 includes a monitoring unit 121, a channel managing unit 122, and a layer managing unit 123.

The monitoring unit 121 monitors whether the terminal 200 first attempts to connect to the server 100. If the terminal 200 first connects to the server 100, the monitoring unit 121 receives from the terminal 200 through the communication network 11 terminal basic information including, e.g., the type of terminal so as to ensure the video quality that may be covered by the terminal 200. And, the monitoring unit 121 grasps the type of the terminal using the terminal basic information. At this time, since the clock count of the main processor (CPU) and video playback performance in view of memory vary depending on the type of the terminal, the monitoring unit 121 classifies weighting factors as per the type of terminal as in Table 1 below through a basic performance experiment:

TABLE 1

| CPU Type | Penalty weighting factor | level |
|---|---|---|
| Intel Core | 1.0 | 4.1 |
| AMD Core | | 4 |
| ARM Core | 0.9 | 3.1 |
| ATOM | 0.8 | 3 |

The monitoring unit 121 determines the maximum number of encoding layers that may be consumed through initial connection—hereinafter, referred to as “initial maximum layer number”—based on the terminal basic information. More specifically, the monitoring unit 121 defines an expense function (Lᵢₙᵢₜ) for determining the initial maximum layer number of the terminal 200 by using the weighting factors weighting factors in Table 1. The expense function is as in Equation 1:

Lᵢₙᵢₜ=P×CPU_{clock}×CPU_{core}, (0≦P≦1) [Equation 1]

Here, P is a weighting factor pre-defined depending on the type of a terminal as in Table 1, CPU_{clock} is the clock count of the terminal, and CPU_{core} is the number of processor cores in the terminal (in case of multi-core process).

In case K layers are serviceable, the monitoring unit 121 determines the initial maximum layer number as in Equation 2 by using the expense function (Lᵢₙᵢₜ). The monitoring unit 121 transfers the determined initial maximum layer number to the layer managing unit 123.

$$N = \{ \begin{matrix}1 , & if {L}_{init} < {TH}_{1} \\ 2 , & if {L}_{init} < {TH}_{2} \\ ⋮ , & ⋮ \\ K , & otherwise .\end{matrix} \qquad [ Equation 2 ]$$

Here, N is the initial maximum layer number that refers to the maximum number of layers consumable at first stage by the terminal, and THi is a reference value for determining the initial maximum layer number, which may be defined by various methods as set by a user.

In an embodiment of the present invention, when monitoring channel connectivity, the basic information of the terminal 200 is provided to the server 100 through a TCP (transmission control protocol) signaling scheme, and terminal basic information related to initial access of the terminal 200 is also provided to the server 100 through the same scheme.

The channel managing unit 122 receives channel monitoring information from the monitoring unit 121. The channel managing unit 122 detects channels available for providing services (hereinafter, referred to as “available channel”) and basic bandwidth information (hereinafter, referred to as “bandwidth information”) for each of the available channels by using the channel monitoring information. In other words, the channel managing unit 122 generates the channel management information including the bandwidth of each of the available channels and the number of the available channels. And, the channel managing unit 122 transfers the channel management information to the layer managing unit 123. Here, the channel management information is yielded using TCP/RTCP (real-time transport control protocol) signaling.

And, the channel managing unit 122 theoretically or experimentally calculates data rates up to the maximum number of serviceable layers. For example, as shown in FIG. 4, considering full HD (High Definition) as the maximum quality, data rates up to the maximum number of layers serviceable through a base layer 130, a first layer 131, and a second layer 132 are each calculated. And, the channel managing unit 122 manages information on the calculated data rates up to the maximum number of layers as basic information, and as necessary, transfers the information to the layer managing unit 123.

Further, the channel managing unit 122 theoretically or experimentally calculates information on data consumed by a terminal (data rate) and information on capacity (bandwidth information) of an available channel that is connected to the communication network 11 and that may be used for providing a service. For example, as shown in FIG. 5, in case channels are provided by a first supplier 400, a second supplier 410, and a third supplier 420, the channel managing unit 122 calculates information on channel capacity that may be provided by each supplier. The channel managing unit 122 calculates information on data consumed by first to fifth terminals 500a to 500e. And, the channel managing unit 122 manages the calculated bandwidth of the available channels and consumed data information as basic information and as necessary transfers it to the layer managing unit 123.

Referring back to FIG. 2, the layer managing unit 123 receives the initial maximum layer number determined when the terminal 200 first accesses from the monitoring unit 121. The layer managing unit 123 transfers the initial maximum layer number to the encoder 110 and it may be then transmitted as a bit stream with the initial maximum layer number reflected.

Meanwhile, the layer managing unit 123 receives the channel management information from the channel managing unit 122. The layer managing unit 123 selectively determines the number of layers to be used for encoding (hereinafter, referred to as “adaptive layer number”) based on the channel management information, i.e., the bandwidth information of each available channel and the number of available channels. In other words, the layer managing unit 123 determines the state in which the number of available channels changes, and if the number of available channels changes, determines the adaptive layer number based on a sum of the bandwidths of the changed available channels. In an embodiment of the present invention, since the bandwidth information of each available channel is previously known, even when the available channels are changed, the previously known bandwidth information is used to figure out the sum of the bandwidths of the changed available channels.

More specifically, the layer managing unit 123 determines whether the connection state of the available channels is changed using the channel management information. That is, if it is determined that there is no change in the number of available channels or in case the number of available channels is changed but the bandwidth is not sufficient, the layer managing unit 123 provides a scalable video service while maintaining the current number of layers. However, if as a result of the determination the number of available channels is changed, the layer managing unit 123 compares a sum of bandwidths of the changed available channels with the data rate of the initial maximum layer number and determines the adaptive layer number (N_{adaptive}) as in Equation 3:

$${N}_{adaptive} = \{ \begin{matrix}M layers , & if {BW}_{s} > bitrate of N layers , \\ M - 1 layers , & if {BS}_{s} > bitrate of N - 1 layers , \\ ⋮ , & ⋮ \\ 1 layers , & otherwise .\end{matrix} \qquad [ Equation 3 ]$$

Here, SWs is the sum of the bandwidths of the changed available channels (e.g., LTE, 4G, 3G, etc.), N is the initial maximum layer number, and M is the maximum number of layers serviceable by the encoder. Here, the maximum number (M) of layers serviceable by the encoder is smaller than the maximum number (N) of layers consumable at initial stage by the terminal.

In other words, in case available channels are reduced from three to two while the terminal 200 provides a service by the initial maximum layer number and then the terminal 200 are connected to the two channels, the layer managing unit 123 compares the data rate of the initial maximum layer number (N) of the terminal 200 with a sum SWs (hereinafter, referred to as “bandwidth sum”) of bandwidths of the two channels to which the terminal 200 are connected. If a result of the comparison shows the bandwidth sum SWs is larger than the data rate of the initial maximum layer number (N), the layer managing unit 123 determines the adaptive layer number as M. In case as the result of the comparison the bandwidth sum SWs is smaller than the data rate of the initial maximum layer number (N) of the terminal 200, the layer managing unit 123 compares the data rate of the initial maximum layer number (N−1) with the bandwidth sum SWs. If the result shows the bandwidth sum SWs is larger than the data rate of the initial maximum layer number (N−1), the layer managing unit 123 determines the adaptive layer number as M−1. If the bandwidth sum SWs is smaller than the data rate of the initial maximum layer number (N−1), the layer managing unit 123 compares the data rate of the initial maximum layer number (N−2) with the bandwidth sum SWs. The layer managing unit 123 performs the same process to determine the adaptive layer number.

After determining the adaptive layer number, the layer managing unit 123 applies a change in the number of layers to use GOP unit as a standard. Specifically, if the adaptive layer number is entered with the number of layer changed in the current GOP unit, the layer managing unit 123 controls a time of transfer such that the changed number of layers may be applied in the next GOP unit after the current GOP unit is terminated. And, the layer managing unit 123 transfers the adaptive layer number to the encoder 110 at the determined transfer time so that the changed number of layers is reflected when the bit stream is transmitted.

For example, as shown in FIG. 6, in case while a service is being provided through initial maximum layer numbers 600a, 600b, and 600c with three channels such as WIFI 610a, 4G 610b, and 3G 610c connected during the first GOP unit, access to the WIFI channel 610a is impossible from the start P1 of the second GOP unit, and thus only the other two channels, 4G 610b and 3G 610c, remain connected, the layer managing unit 123 stands by until the first GOP unit is terminated. And, at the start P1 of the second GOP when the first GOP unit is terminated and the channels are reduced to the two channels, the layer managing unit 123 controls the transfer time such that the scalable video service is provided through the base layer 600a and the first layer 600b without using the second layer 600c and transfers it to the encoder 110. In other words, even though a service using three layers 600a, 600b, and 600c are possible, if a terminal to receive the service is under the situation where the terminal may be provided with the service through only two layers, the two layers only are used to provide the service. Although an example where channels decrease has been described with reference to FIG. 6, the present invention is not limited thereto. Even when channels increase, the number of layers may be likewise increased on a per-GOP unit basis, thereby providing services.

Turning back to FIG. 2, the terminal 200 may be a mobile terminal, a PC (Personal Computer), or a laptop computer that communicates with the server 100 through the communication network 11. The terminal 200 includes a decoder 210. The decoder 210 receives a bit stream with the adaptive layer number controlled depending on the number of available channels and the bandwidth of each of the available channels from the server 100 and decodes the bit stream. At this time, the decoder 210 may decode the bit stream and may reproduce the bit stream as many times as the number of layers.

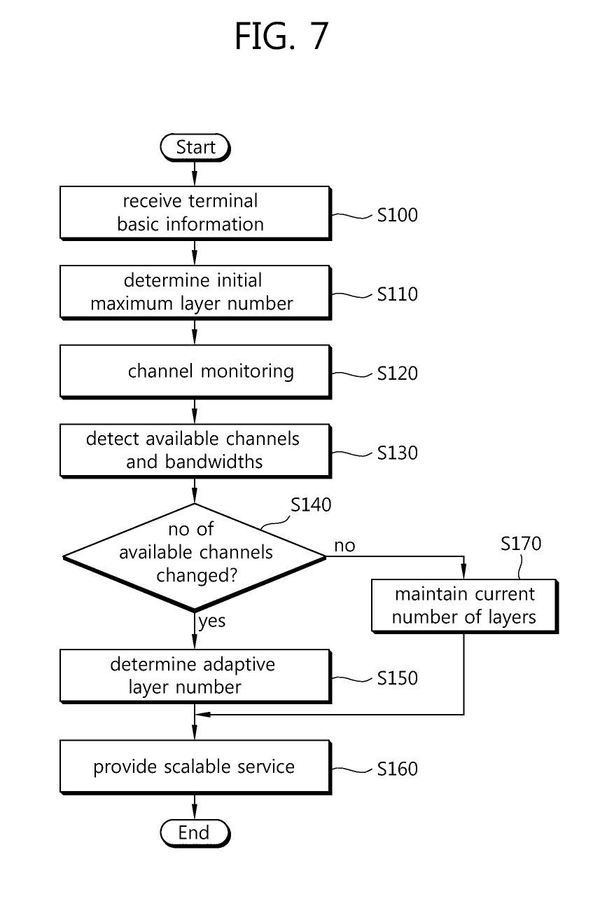

FIG. 7 is a flowchart illustrating a method for providing a multi-channel connection-based scalable video service according to an embodiment of the present invention.

As shown in FIG. 7, the monitoring unit 121 of the adaptive layer selecting unit 120 according to an embodiment of the present invention receives terminal basic information to ensure video quality that may be covered by the terminal 200 when the terminal 200 first accesses to the server 100 (S100). The monitoring unit 121 grasps the type of the terminal by using the terminal basic information and determines an initial maximum layer number by using a weighting factor per terminal type (S110). The monitoring unit 121 transfers the determined initial maximum layer number to the encoder 110 through the layer managing unit 123.

Meanwhile, after the initial access is complete, the monitoring unit 121 monitors the connection state of at least one channel connected through the communication network 11. The monitoring unit 121 generates channel monitoring information by using a monitored result and transfers it to the channel managing unit 122 (S120).

The channel managing unit 122 detects available channels and bandwidth information of each of the available channels using the channel monitoring information (S130). In other words, the channel managing unit 122 generates channel management information including the number of available channels that may be used for service provision and bandwidth information of each available channel and transfers the channel management information to the layer managing unit 123.

The layer managing unit 123 receives the channel management information from the channel managing unit 122. The layer managing unit 123 determines whether the number of available channels is changed using the channel management information (S140).

In case it is determined in step S140 that the number of available channels is changed, the layer managing unit 123 determines an adaptive layer number to be used for encoding based on a sum of the bandwidths of the changed available channels (S150). And, the layer managing unit 123 transfers the adaptive layer number to the encoder 110 and provides a scalable video service (S160).

In case it is determined in step S140 that the number of available channels is not changed or that the number of available channels changes but the bandwidth is not sufficient, the layer managing unit 123 maintains the current number of layers and provides a scalable video service (S170).

Although preferred embodiments of the present invention have been described with reference to the accompanying drawings, it should not be construed as limiting the scope of the invention, and it should be understood that various modifications and variations may be made to the present invention by one of ordinary skill in the art without departing from the spirit and scope of the invention as defined by the following claims.

What is claimed is:

1. An adaptive layer selecting apparatus comprising:
a monitoring unit monitoring a connection state of at least one channel connected through a communication network;
a channel managing unit detecting available channels to be used for providing a service based on a result of the monitoring; and
a layer managing unit determining the number of adaptive layers to be used for encoding based on bandwidths of changed available channels when the number of the available channels is changed.

2. The adaptive layer selecting apparatus of claim 1, wherein the monitoring unit detects the type of a terminal first connected through the communication network.

3. The adaptive layer selecting apparatus of claim 2, wherein the monitoring unit defines an expense function by using a main processor clock count and the number of processor cores determined according to the type of the terminal.

4. The adaptive layer selecting apparatus of claim 3, wherein the monitoring unit determines the initial maximum number of layers consumable by the terminal when the terminal first accesses by using the expense function and a weighting factor predetermined according to the type of the terminal.

5. The adaptive layer selecting apparatus of claim 4, wherein when the number of the available channels is changed while a service is being provided in the initial maximum layer number, the layer managing unit determines the adaptive layer number based on a sum of the bandwidths of the changed available channels.

6. The adaptive layer selecting apparatus of claim 5, wherein the channel managing unit transfers channel management information including the number of the available channels and the bandwidth of each available channel to the layer managing unit.

7. The adaptive layer selecting apparatus of claim 6, wherein the layer managing unit determines whether the number of the available channels is changed using the channel management information.

8. The adaptive layer selecting apparatus of claim 7, wherein when the number of the available channels is changed, the layer managing unit determines the adaptive layer number by adjusting the maximum number of layers serviceable by an encoder according to a result of comparison between a data rate of the initial maximum layer number and the sum of the bandwidths of the changed available channels.

9. The adaptive layer selecting apparatus of claim 8, wherein the in a case where the number of the available channels is not changed or in a case where the number of the available channels is changed but the bandwidths of the changed available channels are not sufficient, the layer managing unit determines the current number of layers as the adaptive layer number.

10. An adaptive layer selecting method comprising:
monitoring a connection state of at least one channel connected through a communication network;
detecting available channels to be used for providing a service based on a result of the monitoring; and
determining the number of adaptive layers to be used for encoding based on bandwidths of changed available channels when the number of the available channels is changed.

11. The adaptive layer selecting method of claim 10, wherein the monitoring comprises:
detecting the type of a terminal first connected through the communication network;
defining an expense function by using a main processor clock count and the number of processor cores determined according to the type of the terminal; and
determining the initial maximum number of layers consumable by the terminal when the terminal first accesses by using the expense function and a weighting factor predetermined according to the type of the terminal.

12. The adaptive layer selecting method of claim 10, further comprising determining whether the number of the available channels is changed using channel management information including the number of the available channels and the bandwidth of each available channel.

13. The adaptive layer selecting method of claim 12, wherein determining the adaptive layer number comprises:
when the number of the available channels is changed, determining the adaptive layer number by adjusting the maximum number of layers serviceable by an encoder according to a result of comparison between a data rate of the initial maximum layer number and the sum of the bandwidths of the changed available channels; and
in a case where the number of the available channels is not changed or in a case where the number of the available channels is changed but the bandwidths of the changed available channels are not sufficient, determining the current number of layers as the adaptive layer number.

14. A server comprising:
an adaptive layer selecting unit monitoring a connection state of at least one channel connected through a communication network, determining whether the number of available channels based on a result of the monitoring, and determining the number of adaptive layers to be used for encoding; and
an encoder performing encoding based on the adaptive layer number transferred from the adaptive layer selecting unit.

15. The server of claim 14, wherein the adaptive layer selecting unit controls a transfer time such that, when the number of the available channels is changed during a first GOP unit and the adaptive layer number is determined, the adaptive layer number applies at a start of a second GOP unit after the first GOP unit is terminated.

16. The server of claim 14, wherein the adaptive layer selecting unit determines the initial maximum number of layers consumable by a terminal that first accesses through the communication network.

17. The server of claim 16, wherein when the number of the available channels is changed while a service is provided in the initial maximum layer number, the adaptive layer selecting unit determines the adaptive layer number by comparing a sum of bandwidths of the changed available channels with a data rate of the initial maximum layer number.

18. An adaptive layer selecting method by a server, the method comprising:
monitoring a connection state of at least one channel connected through a communication network by an adaptive layer selecting unit;
determining whether the number of available channels based on a result of the monitoring and determining the number of adaptive layers to be used for encoding by the adaptive layer selecting unit;
transferring the adaptive layer number to an encoder by the adaptive layer selecting unit; and
performing encoding based on the adaptive layer number by encoder.

19. The adaptive layer selecting method by the server of claim 18, further comprising:
monitoring a terminal that first accesses through the communication network by the adaptive layer selecting unit; and
determining the initial maximum number of layers consumable by the terminal when the terminal first accesses based on the type of the terminal by the adaptive layer selecting unit.

20. The adaptive layer selecting method of the server of claim 19, wherein determining the adaptive layer number comprises, by the adaptive layer selecting unit,
determining whether the number of the available channels is changed while a service is provided in the initial maximum layer number;
in a case where the number of the available channels is changed, determining the adaptive layer number by adjusting the maximum number of layers serviceable by the encoder according to a result of comparison between a sum of bandwidths of the changed available channels and a data rate of the initial maximum layer number; and
in a case where the number of the available channels is not changed or in a case where the number of the available channels is changes but the bandwidths of the changed available channels are not sufficient, determining the current number of layers as the adaptive layer number.
